(19) United States
(12) Patent Application Publication
(10) Pub. No.: US 2009/0281830 A1
(43) Pub. Date: Nov. 12, 2009

(54) COLLABORATION MARKETPLACE PLATFORM SYSTEM FOR RESEARCH AND MANAGEMENT OF CHRONIC CONDITIONS

(75) Inventors: James McNames, Portland, OR (US); Pedro Mateo Riobo Aboy, Beaverton, OR (US); Andrew Greenberg, Portland, OR (US)

Correspondence Address: ABOY&ASSOCIATES PC;Dr. Mateo Aboy #64040, www.aboypatentlaw.com, 522 SW 5th Ave, Suite 1265, Portland, OR, 97204, US

(73) Assignee: APDM, INC, Portland, OR (US)

(21) Appl. No.: 12/436,104

(22) Filed: May 5, 2009

Related U.S. Application Data
(60) Provisional application No. 61/051,066, filed on May 7, 2008.

(51) Int. Cl. G06Q 50/00; H04L 9/32; G06Q 10/00; G06Q 40/00; G06F 3/048

(52) U.S. Cl. 705/2; 713/168; 715/742; 705/37

(57) ABSTRACT

An integrated collaborative platform which allows for data sharing, data analysis, knowledge creation and sharing, problem solving, trading, and accelerated scientific discovery by collaborating teams which may be formed on an ad-hoc basis among users of the system is disclosed. The platform is designed to accelerate research and improve clinical care of chronic conditions. It provides a central place to facilitate interactions between the many different groups that participate in these activities. The central features of the system can be tailored to best suit each chronic condition.

### CROSS REFERENCE TO RELATED APPLICATIONS

This application claims the benefit of U.S. Provisional Application No. 61/051,066, filed on May 7, 2008, which is incorporated herein by reference.

### FEDERALLY SPONSORED RESEARCH

Not Applicable.

### SEQUENCE LISTING OR PROGRAM

Not Applicable.

### BACKGROUND OF THE INVENTION

1. Field of Invention

This invention relates to collaboration systems for clinical research. Specifically, it relates to collaboration systems comprising clinical data, analysis methods, information, knowledge sharing, knowledge discovery, research coordination, mass collaboration, and team forming capabilities.

2. Prior Art

Collaboration systems include any system which enables persons to share data, analyze data, upload data, and share knowledge among a group of users. These systems are well known and a whole industry has emerged to develop and improve upon practical applications that take advantage of the connectivity these networks provide.

As an example, the general system reported in US 2003/0093478 A1 describes a collaboration and innovation system that creates a virtual entrepreneurial work space and facilitates individual and group innovation efforts to solve problems, create intellectual property, and create business opportunities. The system facilitates innovation efforts being done in response to stated problems, opportunities identified in the system or business ideas coming from members of the system network.

In addition to these general collaboration systems, some platforms are designed to bring those having expertise to solve particular problems to those with a need for such expertise. For instance, a system known as Innocentive enables users to post technical or scientific problems for which a solution is needed. Other users can then attempt to provide a solution to the problem in order to obtain a reward offered by the user posting the problem to be solved. United States Patent 20070244840 and US20070239464 describe the invention of improved systems and methods for enabling Seekers to create and post challenges for Solvers in a networked system.

None of the currently available systems have been designed to accelerate research, knowledge discovery and dissemination, data sharing, and data analysis for biomedical purposes. Currently there is very little coordination among the different groups involved in the research and clinical care for chronic conditions. Some foundations provide discussion forums that permit patients and caregivers to interact with one another and doctors. There are also some public online depositories for research data, such as Physionet. However these are not specific to each chronic condition and do not provide integrated data sharing, analysis capabilities, and mass collaboration opportunities. At the moment, there is no commercial system or prior art describing collaboration systems intended for clinical research having both clinical data, analysis methods, information, knowledge sharing, knowledge discovery, research coordination, public dissemination, and team forming and mass collaboration capabilities.

The notion of constantly uploading new data and analyzing it as it becomes available runs contrary to the way most trials are conducted. Most researchers try hard to design prospective studies in which they rigorously test a specific hypothesis. In order to do these correctly, the data is often hidden from the researchers as well as the subjects. This is to ensure that the data does not affect the experiment. The statistical analysis for scientific studies is designed so that a single yes-no decision (or series of decisions) is made at the end of the study. The analysis is designed such that the probability that the null hypothesis is rejected when it is actually true (i.e., the probability that a new therapy is declared as better, when it actually is not) is known. This is sometimes called a false positive or type I error. Typically this probability is either 0.01 or 0.05.

This analysis breaks if the data is continuously reviewed and the data may be aborted at any time or, less likely, success is declared early. There is also a temptation to analyze the data differently or use different metrics if the initial data is not favorable to the process. This process of examining the data before the experiment is complete is sometimes called data snooping. Although this invalidates the statistical analysis, many researchers do this anyway and do not report it.

There is another process that uses largely the same methodology called exploratory data analysis or data mining. Within the context of the scientific method, this is the process of analyzing data to generate new hypotheses. Those new hypotheses cannot then be tested on the same data used to suggest or identify the hypotheses, because the probabilities of a false positive cannot be established. A thorough analysis of data also tends to identify anomalies that may suggest a statistical difference, but is not a real effect that would be repeatable in subsequent studies. The only way to rigorously test these hypotheses is to conduct another prospective study with new subjects.

At the moment, there is no commercial system of prior art describing collaboration systems intended for clinical research, collaboration, and dissemination, having both clinical data, analysis methods, information, knowledge sharing, knowledge discovery, research coordination, and team forming capabilities which is consistent with the process of knowledge discovery and the scientific method.

### SUMMARY

In its most basic form, the invention comprises an integrated collaborative platform which allows for data sharing, data analysis, knowledge creation and sharing, problem solving, and accelerated scientific discovery by collaborating teams which may be formed on an ad-hoc basis among users of the system. The platform is designed to accelerate research and improve clinical care of chronic conditions. It provides a central place to facilitate interactions between the many different groups that participate in these activities. The central features of the system can be tailored to best suit each chronic condition.

### BRIEF DESCRIPTION OF THE DRAWINGS

FIG. 1 illustrates a block diagram representing the basic components of an embodiment of the present invention and how different users may interact with the system.

FIG. 2 illustrates an example of a system architecture according to one embodiment of the invention.

### DETAILED DESCRIPTION

In one embodiment the system is created as a web server that runs an integrated online platform designed for mass collaboration. It supports encrypted data transfer through standard encryption protocols. A relational database such as MySQL is used to store user profiles, protocols, study data, study results, and collaboration team information. The system is built using standard server practices with the best practices of security, backups, and redundancy. All users are authenticated and the data is carefully controlled to ensure compliance with federal regulatory requirements such as the Health Information Portability and Accountability Act (HIPAA).

According to one embodiment, the system includes a software module to enable researchers to conduct prospective trials in which the hypotheses are stated prior to any data collection and the statistical analysis is automated and locked down. This permits researchers from trying other analysis methodologies during the course of their study until they find one that is favorable, which leads to a higher prevalence of false positives than expected.

According to another embodiment, the system further includes a software module to enable analysts and researchers to perform an exploratory analysis of the data as it arrives. This embodiment is designed to facilitate faster identification of new metrics and provide the rest of the community with faster information about whether new therapies look promising or not.

Another embodiment of the system further includes a software module to enable the research community to conduct larger meta studies with the raw data. Typically, a meta analysis, which pools the data together from multiple studies, can only be applied to the published results. The system permits the meta analysis to be performed on the raw data, which leads to more statistical power and faster discovery of new knowledge.

According to another embodiment, the system includes a contract marketplace and a prediction market similar to Intrade (www.intrade.com) to combine the estimates from many different people about the probability of the outcome of ongoing studies and trials. This uses crowdsourcing and members of the crowd (collaborators or users) have a financial incentive to be right. The estimated probability of outcomes benefits the larger community by providing useful information about where to invest resources in the most promising types of new therapy.

Another embodiment combines each of the embodiments described above into a single integrated collaboration platform which includes software modules to enable for data sharing, data analysis, knowledge creation and sharing, problem solving, predictive market analysis, and accelerated scientific discovery by collaborating teams which may be formed on an ad-hoc basis among users of the system. The platform is designed to accelerate research and improve clinical care of chronic conditions. It provides a central place to facilitate interactions between the many different groups that participate in these activities. The central features of the system can be tailored to best suit each chronic condition. In this embodiment, the system brings clinical researchers, engineers, scientists, medical doctors, patients, family, pharmaceutical companies, statisticians, research institutions, investors, and traders together in one “place” (integrated collaboration platform system) and promotes community and collaboration on chronic conditions. In this embodiment, data may be open and anyone can download it or access it. The system may include sunrise dates for new data after which the data becomes open to the public. Additionally, automatic data analysis is conducted using state of the art biomedical signal processing algorithms and reports are generated. As a marketplace, investors may help fund studies, drug trials, new technologies, and other improvements in therapies. Patients, researchers, clinicians, and collaborators can suggest and design trials for new therapies.

According to one embodiment, the integrated system described above is focused on Parkinson's disease. In another embodiment the system is focused on essential tremor. In another embodiment the system is focused on general movement disorders. According to another embodiment the system is focused on hypertension. In another embodiment the system the is focused on diabetes.

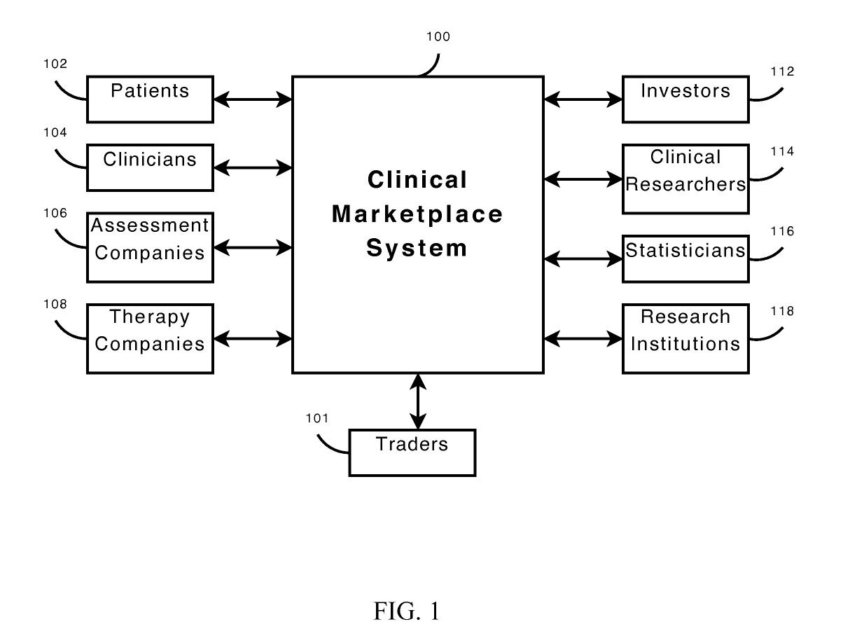

FIG. 1 illustrates one embodiment of the system as a clinical marketplace platform and how it acts as a central location for many different users involved in clinical care and research to interact and collaborate. In one embodiment of the system, the online platform provides one or more types of functionality to each user of the system.

Collaboration systems of the present invention may be provided using any suitable interactive technology that enables the system users to accomplish the task described herein. Those skill in the art will appreciate that using the description and uses examples provided in this specification it is a routine matter to provide working systems which will work on a variety of known and commonly available technologies capable of incorporating the features of the invention described herein. The following descriptions explain how each type of user may use the platform system 100; the system includes standard software modules to incorporate the functionality to accommodate each of these uses. In one embodiment, patients 102 may use the platform to: 1) Learn about the latest results, clinical trials, and clinical studies. 2) Upload data measured either from devices, self reports, or other tests that can be administered in their natural living environment. 3) View how their condition compares to others with a similar state of disease severity, age, and other relevant criteria. 4) View their clinical history that shows how their disease is progressing over time. 4) Control who has access to their data. 5) Learn about ongoing trials that they may be able to participate in. 6) Suggest new clinical studies and alternative therapies to the research community. Clinicians 104 may use the platform to: 1) Learn about the latest results, clinical trials and clinical studies. 2) View reports that show the history and latest results of assessment of their patients. 3) Gather feedback from the community about how to improve the rigor of their study design and analysis techniques. 4) Suggest new studies, drug trials, assessment methods, and therapies. Assessment companies 106 that provide devices or other means with the ability to assess the severity or degree of progression in a chronic condition may use the platform to 1) Find clinical partners capable of conducting clinical research studies to rigorously determine the clinimetric properties of their methods. 2) Provide funding to their clinical partners. Therapy companies 108 may use the platform to: 1) Recruit clinical researchers to participate in clinical trials. This may be done through a bidding process where clinicians bid to participate in a clinical trial. 2) Recruit statisticians to design studies and perform the statistical analysis. This may be done through a bidding process where statisticians bid to assist with a clinical trial. 3) Manage collection, storage, access, and security of data from the clinical trial. 4) Manage analysis and access to results. Traders 110 may use the platform as a prediction market to facilitate trading between individuals about the outcomes of clinical studies and trials. An example of this for other types of prediction markets is Intrade. One benefit of the prediction market is that it may provide information about the probability of the outcome during on-going studies and drug trials. This may accelerate the process of knowledge discovery by providing a financial incentive for investors to estimate the probability of outcome as accurately as possible. Investors 112 may use the platform to contribute to the funding of clinical studies and trials. This may be philanthropic or contractual. The platform may facilitate this by providing a means for investors to direct funding directly to clinical studies. Clinical researchers 114 may use the platform to: 1) Manage the data collection and analysis for their research studies. 2) Solicit funding for their research. 3) Partner with other clinical researchers, analysts, and statisticians. Statisticians 116 may use the platform to 1) Design clinical studies and trials. 2) Analyze the data collected from clinical studies and trials. 3) Provide funding for their services. Research institutions 118 may use the platform to ensure all regulatory requirements for conducting clinical research and trials are met, and as a source of funding for clinical research.

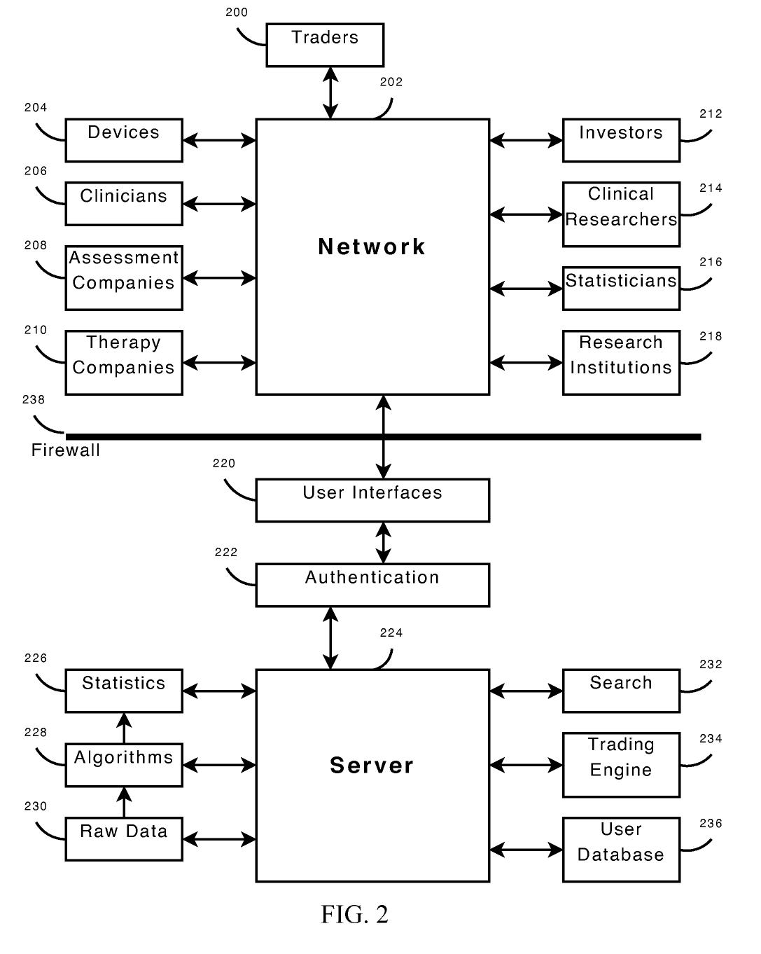

FIG. 2 illustrates an example of a system architecture according to one embodiment of the invention. In this embodiment, traders 200, devices 204, clinicians 206, assessment companies 208, therapy companies 210, investors 212, clinical researchers 214, statisticians 216, and research institutions 218 are connected to a network 202 with access to a central server 224 through a secured firewall 238. Each user goes through a user-specific authentication procedure 222 and has a user-specific interface 220. According to this embodiment the system components comprise a central server 224, a database to store raw data 230, algorithms 228 to analyze raw data and create user specific reports, a user database 236, a statistics module 226, a trading engine 234, and search capabilities 232.

While particular embodiments of the present invention have been described, it is understood that modifications and generalizations will be apparent to those skilled in the art without departing from the spirit of the invention.

The invention claimed is:

1. A collaboration system for clinical research comprising a server, said server comprising:
(a) a web-enabled graphical user interface to enable a user to securely authenticate, navigate through a plurality of software modules running on said server, and transfer encrypted data to and from said server;
(b) a relational database to store user profiles, protocols, clinical data, research data, study results, and collaboration team information;
(c) a web-enabled software module to facilitate collaboration among clinical researchers, statisticians, clinicians, medical doctors, research institutions, therapy companies, assessment companies, patients, investors, devices, and traders; and
(d) a plurality of statistical signal processing algorithms to automatically analyze said clinical data and said research data, and create user specific reports of the results.

2. A collaboration system according to claim 1, further comprising a software module for enabling researchers to conduct prospective clinical trials in which a hypothesis is stated prior to any data collection and statistical analysis is automated and locked down.

3. A collaboration system according to claim 2, further comprising a trading engine and software module to implement a contract marketplace and a predictive market for investors to fund clinical studies, clinical trials, new technologies, and new therapies.

4. A collaboration system according to claim 3, further comprising a software module for enabling researchers and analysts to perform exploratory analysis of said clinical and said research data.

5. A collaboration system according to claim 4, further comprising a software module for a research community to conduct larger meta studies directly on said clinical data and said research data.

6. A collaboration system according to claim 5, further comprising a software module for sharing said clinical data after a pre-determined sunrise date.

7. A collaboration system according to claim 6, further comprising a software module for enabling researchers to upload and test new biomedical signal processing algorithms and report results on said clinical data and said research data.

8. A collaboration system according to claim 7, further comprising a software module for enabling clinical researchers to partner with other clinical researchers, analysts, statisticians, therapy companies, assessment companies, and investors.

9. A collaboration system according to claim 8, further comprising a software module for enabling medical devices to directly upload data to the server wirelessly.

10. A collaboration system according to claim 9, further comprising a software module for designing and managing clinical studies and trials.

11. A collaboration system according to claim 10, wherein the system is especially adapted for research and collaboration in movement disorders including storage of raw inertial data directly from medical devices, analysis of inertial data using automatic algorithms, collaboration, and sharing.
